(19) United States
(12) Patent Application Publication
(10) Pub. No.: US 2024/0081441 A1
(43) Pub. Date: Mar. 14, 2024

(54) Antiviral formulation, antiviral filtering material, methods of preparation thereof and antiviral face mask

(71) Applicant: ArcelorMittal, Luxembourg (LU)

(72) Inventors: Abel ALVAREZ-ALVAREZ, Oviedo, Asturias (ES); Alvaro MANJON FERNANDEZ, Oviedo, Asturias (ES); Luis Miguel SANZ MORAL, Gozon, Asturias (ES); David NORIEGA PEREZ, Oviedo, Asturias (ES); Jorge RODRíGUEZ GARCíA, Avilés, Asturias (ES); Laura MEGIDO FERNANDEZ, Gijon (ES); Sivasambu BOHM, Godmanchester, Cambridgeshire (GB); Roberto SUAREZ SANCHEZ, Avilés, Asturias (ES); Marcos PEREZ RODRIGUEZ, Cangas Del Narcea, Asturias (ES)

(21) Appl. No.: 18/269,626

(22) PCT Filed: Dec. 17, 2021
(86) PCT No.: PCT/IB2021/061902

§ 371 Date: Jun. 26, 2023

(30) Foreign Application Priority Data
Dec. 30, 2020 (WO) PCT/IB2020/062539

(51) Int. Cl. A41D 13/11; A01N 25/10; A01N 25/28; A01N 59/20; A01P 1/00; A41D 31/30; A62B 23/02; B22F 1/054; B22F 1/103; B22F 1/16; D06M 11/74; D06M 11/83; D06M 15/263; D06M 15/564; D06M 16/00

(52) U.S. Cl. CPC A41D 13/1192; A01N 25/10; A01N 25/28; A01N 59/20; A01P 1/00; A41D 31/305; A62B 23/025; B22F 1/056; B22F 1/103; B22F 1/16; D06M 11/74; D06M 11/83; D06M 15/263; D06M 15/564; D06M 16/00; B22F 2301/10; B22F 2302/25; B22F 2304/052; D06M 2101/06

(57) ABSTRACT

A first subject of the present invention has an antiviral formulation with metallic copper particles in an unoxidized form and having a median particle diameter inferior or equal to 200 nm, graphene oxide or reduced graphene oxide, and a bonding matrix material. A second subject of the invention has an antiviral filtering material with a layer of textile and at least one layer of an antiviral coating comprising metallic copper particles in an unoxidized form and having a median particle diameter inferior or equal to 200 nm, graphene oxide or reduced graphene oxide, and a bonding matrix into which both metallic copper particles and graphene oxide or reduced graphene oxide are anchored. The invention also concerns methods of preparation of the antiviral formulation and of the antiviral filtering material. Finally, the invention includes an antiviral face mask with a layer of textile coated with the antiviral formulation.

The present invention mainly relates to an antiviral formulation which is able to be used for several applications. Especially, the antiviral formulation can be used for coating a textile substrate in the preparation of an antiviral filtering material. The present invention therefore also relates to an antiviral filtering material prepared with said antiviral formulation. The present invention also relates to an antiviral face mask comprising said antiviral filtering material. The present invention finally concerns a method of preparation of an antiviral formulation and a method of preparation of an antiviral filtering material.

### BACKGROUND

There is an urgent need for effective means for preventing viruses in the air or onto surfaces from entering the human body, such as SARS-CoV-2.

An antibacterial mask containing graphene oxide and copper-silver nanocomposites is known from the publication CN108378440. The antibacterial formulation is prepared from silver nitrate and copper nitrate.

### SUMMARY OF THE INVENTION

Silver is however considered as having a negative impact on human health. Furthermore, copper salts do not have any known antiviral properties. Moreover, copper salts may be considered as toxic. Finally, the metallic salts are able to be released easily and first wash of the mask will then lead to lose the required antibacterial properties.

An aim of the present invention is therefore to remedy the drawbacks of the prior art by providing an antiviral and nontoxic formulation.

An aim of the invention is further to provide an antiviral formulation with a stable antiviral activity while avoiding the leaching of the active components. An aim of the invention is also to provide an antiviral filtering material with an improved antiviral activity and a good breathability.

An aim of the invention is further to provide an antiviral filtering material avoiding or at least limiting leaching of the active components after washing.

An aim of the invention is finally to provide a method for preparing the antiviral formulation and a method for preparing the antiviral filtering material, said methods being scalable and inexpensive.

Another aim of the invention is to provide an antiviral face mask.

For this purpose, a first subject of the present invention consists of an antiviral formulation comprising metallic copper particles in an unoxidized form and having a median particle diameter inferior or equal to 200 nm, graphene oxide or reduced graphene oxide, and a bonding matrix material.

The antiviral formulation according to the invention may also have the optional features listed below, considered individually or in combination:
The metallic copper particles are metallic copper nanoparticles;
the metallic copper particles and the graphene oxide or the reduced graphene oxide are chemically bonded;
the bonding matrix material comprises a water-based resin;
the water-based resin is a polyurethane resin, an acrylic resin, a polyester resin, oligomers or mixtures thereof;
the water-based resin is polyurethane resin or acrylic resin, wherein the ratio between graphene oxide or reduced graphene oxide, and metallic copper particles is between 62:1 to 1:1, and wherein the ratio between graphene oxide or reduced graphene oxide and copper suspension, and the resin is between 1:1 and 600:1;
the formulation further comprises a functionalized nanosilica component;
alternatively, the bonding matrix material comprises an alkaline hydrolyzed epoxy silane;
in this case, the copper particles are encapsulated, for example in glycerin, polyvinyl acetate, or lignin.

A second subject of the invention consists of an antiviral filtering material comprising a layer of textile and at least one layer of an antiviral coating comprising metallic copper particles in an unoxidized form and having a median particle diameter inferior or equal to 200 nm, graphene oxide or reduced graphene oxide, and a bonding matrix into which both metallic copper particles and graphene oxide or reduced graphene oxide are anchored.

The antiviral filtering material according to the invention may also have the optional features listed below, considered individually or in combination:
the bonding matrix further comprises a functionalized nanosilica component;
the bonding matrix comprises a water-based resin;
the water-based resin is a polyurethane resin, an acrylic resin, a polyester resin, oligomers or mixtures thereof;
the water-based resin is polyurethane resin or acrylic resin, wherein the ratio between graphene oxide or reduced graphene oxide, and metallic copper particles is between 62:1 to 1:1, and wherein the ratio between graphene oxide or reduced graphene oxide and copper suspension and the resin is between 1:1 and 1500:1, preferably between 1:1 and 150:1;
alternatively, the bonding matrix comprises a functionalized nanosilica network into which both graphene oxide and metallic copper particles are chemically bonded;
the textile comprises natural fibers such as lignin fibers and/or cotton, synthetic fibers or a mixture thereof.

A third subject of the invention consists of a method of preparation of an antiviral formulation wherein said method comprises at least the following steps:
preparing in alkaline conditions an aqueous dispersion of metallic copper particles and having a median particle diameter inferior or equal to 200 nm and stabilized graphene oxide or stabilized reduced graphene oxide,
mixing said aqueous dispersion with a bonding matrix material under alkaline conditions so as to obtain an antiviral formulation comprising metallic copper particles in an unoxidized form, graphene oxide or reduced graphene oxide and a bonding matrix material.

The method of the preparation of the formulation according to the invention may also have the optional features listed below, considered individually or in combination:
the preparation of the aqueous dispersion of metallic copper particles and graphene oxide or reduced graphene oxide comprises the following steps:
   stabilizing graphene oxide or reduced graphene oxide by mixing with a solvent, for example water, and a dispersing additive,
   adding metallic copper particles in the solution and high shear mixing the resulting preparation,
   centrifugating the resulting preparation, and
   collecting the supernatant so as to obtain the aqueous dispersion of metallic copper particles and stabilized graphene oxide or stabilized reduced graphene oxide,
   wherein all these operations are conducted under alkaline conditions.
the bonding matrix material comprises polyurethane resin, acrylic resin, polyester resin, oligomers or a mixture thereof.
the method further comprises a further step of adding an aqueous dispersion of functionalized nanosilica after mixing the aqueous dispersion with the bonding matrix material.

A fourth subject of the invention consists of another method of preparation of an antiviral formulation according to a second embodiment, wherein said method comprises at least the following steps:
encapsulating metallic copper particles having a median particle diameter inferior or equal to 200 nm,
adding the epoxy silane to the encapsulated metallic copper particles,
hydrolyzing the epoxy silane under sol-gel process conditions,
adding graphene oxide or reduced graphene oxide under sol-gel process conditions,
wherein all the steps are operated under alkaline conditions, so as to obtain an antiviral formulation comprising metallic copper particles in an unoxidized form, graphene oxide or reduced graphene oxide, and a bonding matrix material.

The method of preparation of the formulation of the invention according to this second embodiment may also have the optional features listed below, considered individually or in combination:
the epoxy silane is 3-glycidoxypropyltrimethoxysilane.
the encapsulation of the copper particles is operated with glycerin, polyvinyl acetate, or lignin.
the method comprises a further step of adding a water-based resin after adding graphene oxide or reduced graphene oxide.

A fifth subject of the invention consists of a method of preparation of an antiviral filtering material, wherein said method comprises at least the following steps:
preparing an antiviral formulation as previously recited,
supplying a textile and coating said textile with said antiviral formulation, and
curing the coated textile so as to obtain an antiviral filtering material.

The method of preparation of the filtering material according to the invention may also have the optional features listed below, considered individually or in combination:
the step of coating the textile with the antiviral formulation is a dip coating, screen printing, spray coating or roller coating.
the curing of the coated textile is operated at a temperature comprised between 70 and 230° C. during 1 to 13 minutes.

Finally, the invention consists of an antiviral face mask comprising a layer of textile coated with an antiviral formulation comprising metallic copper particles in an unoxidized form and having a median particle diameter inferior or equal to 200 nm, and graphene oxide or reduced graphene oxide, and a bonding matrix into which both metallic copper particles and graphene oxide or reduced graphene oxide are anchored.

Advantageously, the antiviral formulation further comprises a functionalized nanosilica component.

Other characteristics and advantages of the invention will be described in greater detail in the following description.

### DETAILED DESCRIPTION

The median particle diameter, also called D50, is the value of the particle diameter when the cumulative percentage by number reaches 50%. Similarly, D90 is the value of the particle diameter when the cumulative percentage by number reaches 90%. The particle size distribution can be determined notably by SEM (Scanning Electron Microscope), by TEM (Transmission Electron Microscope), by laser diffraction notably according to ISO13320:2020, by SAXS (Small Angle X-ray Scattering).

Nanoparticles are particles with a median particle diameter D50 inferior or equal to 100 nm.

### General Presentation of the Formulation:

The invention is based on the combined use of graphene oxide or reduced graphene oxide, metallic copper particles and a bonding matrix material. The invention is further based on the means to keep metallic copper in an unoxidized form by operating under alkaline conditions and/or by encapsulating copper.

In the antiviral formulation of the invention, graphene oxide or reduced graphene acts as trapping means of viruses since both graphene oxide or reduced graphene are negatively charged while the viruses are positively charged. Graphene oxide and reduced graphene therefore involve a barrier effect for the textile which is coated with the antiviral formulation. Furthermore, graphene oxide or reduced graphene oxide is attached to the copper particles which are stabilized, therefore avoiding leaching to the ambient surroundings. Additionally, graphene oxide or reduced graphene oxide plays a role in improving the dispersion and therefore the effectiveness of the copper particles.

Metallic copper is used as antiviral active product in the antiviral formulation of the invention. In order to confer the antiviral effect, copper has to be in an unoxidized form. This is achieved by the specific operating conditions of preparation of the antiviral formulation, i.e. alkaline conditions and/or encapsulation of copper as explained below.

When applied to a textile or to any other kind of surface or substrate to be protected, the copper and also the graphene oxide or the reduced graphene oxide must stay on said surface as long as possible. The bonding matrix forms a network into which the copper particles are anchored for less leaching. In the case of epoxy silane, the bonding matrix forms a 3D silica network to which copper is chemically bonded.

The preparation of the antiviral filtering material is mainly conducted by coating a textile with the antiviral formulation and subsequent thermal curing of the antiviral formulation.

### Metallic Copper Particles in an Unoxidized Form

The main functionality of the copper particles in the antiviral formulation for the filtering antiviral material is to kill viruses. The antiviral property of copper is already known. However, in order to present efficient antiviral properties, the copper must be in an unoxidized form. The oxidation of the copper has therefore to be avoided during the preparation of the formulation in order to stay in an unoxidized form when applied into the substrate. Without willing to be bound by any theory, it is expected that the graphene oxide and reduced graphene oxide improve the dispersibility of the copper particles in the matrix and hence increase the effectiveness of the copper particles in damaging the virus.

As it will be further detailed below, the oxidation of the copper is avoided by operating in alkaline conditions (pH 7 or higher) and/or by encapsulating the copper during the preparation of the antiviral formulation.

Furthermore, using copper particles allows avoiding subsequent leaching contrary to copper salts like copper nitrate. Copper particles also induce an efficient antiviral activity contrary to the ionic forms of copper. The amount of copper in the formulation is therefore directly linked to the antiviral efficiency. Finally, copper has no negative impact on humans as demonstrated by appliances with copper-coated cooking devices.

The stabilization of copper in the formulation and in the subsequent layer applied on textile or on any other substrate is enhanced by the covalent bond that naturally occurs between copper and graphene oxide or reduced graphene oxide as soon as they are mixed together during the preparation of the antiviral formulation.

In the case of using epoxy silane as bonding matrix material and especially when using alkaline-hydrolyzed 3-glycidoxypropyltrimethoxysilane, the copper is also chemically bonded to hydroxyl groups resulting from the hydrolysis of the alkoxy groups of the epoxy silane during a sol-gel processing. The hydroxyl group from the silane is attached to the copper particles, which enables the chemical bond.

In the case of using a water-based resin as bonding matrix material, the copper is anchored into the resin network after thermal curing.

Such bonds and anchoring configuration improve the stabilization of copper and its specific functionalization, and therefore prevent subsequent leaching.

The copper particles have a median particle diameter (D50) inferior or equal to 200 nm. Preferably, they have a particle diameter D90 below 200 nm. This particle size distribution contributes to the stability of the antiviral formulation and to its efficiency.

More preferably, copper particles are nanoparticles. This further improves the efficiency of the formulation.

### Reduced Graphene Oxide—Graphene Oxide

Graphene oxide and reduced graphene oxide are both negatively charged due to the carboxyl groups. Consequently, the main functionality of graphene oxide and reduced graphene oxide is to attract viruses which are positively charged. Carboxyl groups are the only ones known to attract viruses.

Reduced graphene oxide has a low bulk density and higher surface area compared to graphene oxide. However, for costs reasons and thanks to a sufficient level of carboxyl groups, graphene oxide is preferred. More advantageously, the use of graphene oxide allows to improve the dispersion and bonding of copper particles in the matrix, hence increasing the effectiveness of the solution.

Graphene oxide and reduced graphene oxide can be both cost-effectively produced from kish graphite.

According to the invention, a stabilization and eventually an exfoliation of the reduced graphene oxide and the graphene oxide is conducted in order to stabilize the graphene layers and, if applicable, to reduce the number of layers up to one to two stabilized layers thereby incrementing the specific surface area. For this purpose, reduced graphene oxide or graphene oxide is preferably subjected to a high shear mixing operation using dispersing additive, and performed for example with a Silverson mixer at about 8000 rpm, thus forming stabilized monolayer graphene oxide, or stabilized reduced graphene oxide.

The use of graphene oxide or reduced graphene oxide involves the following specific and advantageous functionalities: attracting the virus, improving the dispersibility of copper and stabilizing the copper with the already explained covalent bond between copper and graphene oxide or reduced graphene oxide. Moreover, graphene oxide or reduced graphene oxide, having a negatively charged surfaces, have more attraction to positively-charged textiles increasing the bonding of the antiviral coatings.

The ratio between graphene oxide/reduced graphene oxide and copper has to be optimized taking into account the need of both an antiviral efficacy and an air filtration efficiency. For this purpose, the ratio between graphene oxide/reduced graphene oxide and copper is comprised between 62:1 and 1:1, more preferably between 18:1 and 1:1.

Finally, the resin or silane network resulting from the thermal curing of the antiviral formulation lead to anchoring the graphene oxide or reduced graphene oxide then avoiding its subsequent leaching.

### Bondinq Matrix Material: Water-Based Resin

According to a first embodiment of the invention, the bonding matrix material is a water-based resin. After thermal curing, both copper particles and graphene oxide or reduced graphene oxide are anchored into the resulting bonding matrix since the cross-linking of the resins takes place during the drying and curing steps.

Furthermore, the thermal curing also leads to the bonding of the bonding matrix with the substrate onto which the antiviral formulation has been coated prior thermal curing, then ensuring a solid attachment between them. To summarize, the so-formed network of the bonding matrix after curing act as a chemically bonding agent to the textiles.

All type of resins which are water-based like polyurethane water-based resin, acrylic water-based resin and polyester water-based resin can be used for this purpose.

The preferred resin is a polyurethane resin for example sold according to the commercial reference Alberdingk 9000.

For acrylic water-based resin, commercial references such as Alberdingk AC2410 or Alberdingk AS2685 or a mixture thereof can be used.

Advantageously, the acrylic water-based resin contains amine groups which are well-known biocides with active antiviral effect. Moreover, amine and acrylic groups are preferentially attracting the negatively charged spikes of coronaviruses.

A combination of these acrylic resins may also be used. In particular, an acrylic dispersion comprising Alberdingk® AC2410 and Alberdingk® AS2685 in a ratio between 20:1 and 1:20, more preferably between 5:1 and 1:1, may be used.

Oligomers like Dynasylan 2627 may also be added to the formulation to create a system of oligomers forming a 3D network containing amine group.

A functionalized-nanosilica component like an aqueous dispersion of colloidal nanosilica, for example sold according to the commercial reference Levasil CC301, may be added to the formulation. As the particles of Levasil CC301 have been surface modified with an epoxy silane, the use of such dispersion leads to the creation of a network after thermal curing that allows optimizing air filtration and respirability.

### Bonding Matrix Material: Epoxy Silane Precursor

According to a second embodiment of the invention, the bonding matrix material is an epoxy silane. Epoxy silane is defined as a silane having the following general formulas:

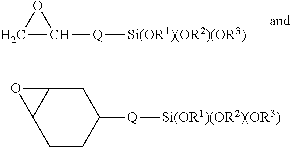

wherein R¹, R² and R³ independently represent alkyl groups having from 1 to 4 carbon atoms. For example, R¹, R² and R³ may independently represent methyl, ethyl, propyl, or butyl. Q represents a divalent organic linking group that is free of interfering groups. Examples of Q include linear, cyclic, and/or branched alkylene, arylene, and combinations thereof, with or without substitution of at least one carbon atom by an N, S, or O atom, sulfonyl group, nitro group, halogen, carbonyl group, or a combination thereof. The epoxy silane compounds may be monomeric, oligomeric, or in some cases even polymeric, provided that they have a polymerizable epoxy group and a polymerizable trialkoxysilyl group.

Typically, the curable epoxy silane compounds are epoxy terminated silane compounds having terminal polymerizable epoxy groups and terminal polymerizable silane groups.

Examples of useful epoxy silanes include glycidoxymethyltrimethoxysilane, glycidoxymethyltriethoxysilane, glycidoxymethyltripropoxysilane, glycidoxymethyltributoxysilane, beta-glycidoxyethyltrimethoxysilane, beta-glycidoxyethyltriethoxysilane, beta-glycidoxyethyltripropoxysilane, beta-glycidoxyethyltributoxysilane, beta-glycidoxyethyltrimethoxysilane, alphaglycidoxyethyltriethoxysilane, alpha-glycidoxyethyltripropoxysilane, alpha-glycidoxyethyltributoxysilane, gamma-glycidoxypropyltrimethoxysilane, gamma-glycidoxypropyltriethoxysilane, gamma-glycidoxypropyltripropoxysilane, gamma-glycidoxypropyltributoxysilane, beta-glycidoxypropyltrimethoxysilane, beta-glycidoxypropyltriethoxysilane, beta-glycidoxypropyltripropoxysilane, beta-glycidoxypropyltributoxysilane, alpha-glycidoxypropyltrimethoxysilane, alpha-glycidoxypropyltriethoxysilane, alpha-glycidoxypropyltripropoxysilane, alpha-glycidoxypropyltributoxysilane, gamma-glycidoxybutyltrimethoxysilane, delta-glycidoxybutyltriethoxysilane, delta-glycidoxybutyltripropoxysilane, delta-glycidoxybutyltributoxysilane, delta-glycidoxybutyltrimethoxysilane, gamma-glycidoxybutyltriethoxysilane, gamma-glycidoxybutyltripropoxysilane, gamma-propoxybutyltributoxysilane, delta-glycidoxybutyltrimethoxysilane, delta-glycidoxybutyltriethoxysilane, delta-glycidoxybutyltripropoxysilane, alpha-glycidoxybutyltrimethoxysilane, alpha-glycidoxybutyltriethoxysilane, alpha-glycidoxybutyltripropoxysilane, alpha-glycidoxybutyltributoxysilane, (3,4-epoxycyclohexyl), methyltrimethoxysilane, (3,4-epoxycyclohexyl) methyltriethoxysilane, (3,4-epoxycyclohexyl)methyltripropoxysilane, (3,4-epoxycyclohexyl)methyltributoxysilane, (3,4-epoxycyclohexyl)ethyltrimethoxysilane, (3,4-epoxycyclohexyl)ethyltriethoxysilane, (3,4-epoxycyclohexyl)ethyltripropoxysilane, (3,4-epoxycyclohexyl)ethyltributoxysilane, (3,4-epoxycyclohexyl)propyltrimethoxysilane, (3,4-epoxycyclohexyl)propyltriethoxysilane, (3,4-epoxycyclohexyl)propyltripropoxysilane, (3,4-epoxycyclohexyl)propyltributoxysilane, (3,4-epoxycyclohexyl)butyltrimethoxysilane, (3,4-epoxycyclohexyl)butyltriethoxysilane, (3,4-epoxycyclohexyl)butyltripropoxysilane, and (3,4-epoxycyclohexyl)butyltributoxysilane.

For example, the epoxy silane is gamma-glycidoxypropyltrimethoxysilane also called GPTMS which is a bifunctional organosilane with three methoxy groups on one side and an epoxy ring on the other.

According to the invention, the GPTMS is used as a silica precursor and its functionalization is conducted under sol-gel processing.

As it will be further explained below in the description of the method of preparation of the antiviral formulation, the GPTMS is hydrolyzed under alkaline conditions during the preparation of the antiviral formulation thus avoiding the oxidation of copper and also leading to bond with the copper particles via the so-formed hydroxyl groups.

The condensation of the hydrolyzed GPTMS takes place during thermal curing thus leading to a very dense 3D network which bonds to the textile via epoxy groups. The silica network is therefore both attached to the textile and to copper as described above. The copper thus remains stabilized in the 3D silica network and is evenly distributed within the network. As it will detailed below, the copper is protected from oxidation by encapsulation during the alkaline hydrolyzation of the GPTMS.

GPTMS may be used alone as bonding matrix material.

A further increase of the filtration efficiency of the resulting antiviral filtering material can be obtained by adding a functionalized nanosilica aqueous dispersion, for example sold according to the commercial reference Levasil CC301, to the epoxy silane. The amount of added functionalized nanosilica aqueous dispersion is preferably in the range of 1 to 8% vol., more preferably 2 to 5% vol of the whole solution, in order to optimize the filtration efficiency.

A further increase of the bonding properties of the antiviral formulation on the substrate can be obtained by adding an oligomer like Dynasylan2627 to create a system of oligomers forming an extra 3D network.

Finally, a water-based resin (such as polyurethane, acrylic, polyester and mixtures thereof) may be also added to the formulation for increasing the bonding of the active particles with the substrate.

### Substrate—Textile

The antiviral formulation of the invention may be used for coating textiles, and more especially for the preparation of antiviral face masks. When coating textiles, the ratio between graphene oxide or reduced graphene oxide and copper suspension and the resin is preferably between 1:1 and 1500:1, more preferably between 1:1 and 150:1.

All type of textile may be used according to the invention. Applications of such textiles may be for surgical gowns, clothes and textiles for hotels.

Preferably, a nonwoven woodpulp PET fabric sold under the commercial reference Sontara® is used. Such fabric comprises around 50, 4% of woodpulp (lignin) and 49, 6% of polyethylene. When using Sontara® fabric, lignin cellulose may be incorporated into the antiviral formulation for cross-linking with the lignin of the substrate, then creating a more stable chemical bonding.

Alternatively, polyester, nylon or a combination of polypropylene and PET (such as for example GeoPunch®100 sold by Geopannel) may be used as substrate.

Other textiles comprising alone or in combination polyester, cellulose and cotton may be used depending to the application.

### Method of Preparation of an Antiviral Formulation Using a Water-Based Resin as Bonding Matrix Material

In order to avoid the oxidation of metallic copper particles during the process, all the steps are conducted under alkaline conditions.

An aqueous dispersion of metallic copper particles and graphene oxide or reduced graphene oxide is firstly prepared by high shear mixing a solution of graphene oxide or reduced graphene oxide (stabilization of the monolayers) with a solvent, for containing a dispersing additive, adding metallic copper particles in the solution, high shear mixing the resulting preparation and collecting the supernatant after centrifugation.

A dispersing additive, such as DISPERBYK-2010 or DISPERBYK-2012 or DISPERBYK-2080, may be used for preparing both the solution of graphene oxide or reduced graphene oxide, and the copper particles solution before mixing them together.

The supernatant is then mixed with the bonding matrix material (water-based resin) still under alkaline conditions.

An aqueous dispersion of functionalized nanosilica (Levasil CC301) may be added after mixing the aqueous dispersion with the bonding matrix material.

The ratio between graphene oxide or reduced graphene oxide and metallic copper particles is between 62:1 and 1:1, more preferably between 18:1 and 1:1. The ratio between the mixture of graphene oxide (or reduced graphene oxide) and copper water-based suspension, and the polyurethane or acrylic resin is between 1:1 and 600:1 when the resin is diluted, and between 1:1 to 3:2 when the resin is undiluted.

### Method of Preparation of an Antiviral Formulation Using an Epoxy Silane as Bonding Matrix Material

This formulation has the advantage of forming a 3D-network that strongly anchors the copper particles, especially by forming a chemical bonding between the silane network and the copper particles thus avoiding the particles leaching.

This formulation involves the hydrolyzation of the epoxy silane under sol-gel process conditions, followed by a condensation that takes place during the subsequent step of thermal curing. The problem of using such formulation is that the most common way to hydrolyze the epoxy silane is under acidic conditions that involves the oxidation of the copper.

According to the invention, a specific method has been developed involving a double protection of the copper particles by operating the hydrolyzation under alkaline conditions and by encapsulating the copper for example in glycerin, polyvinyl acetate, or lignin. Copper oxidation is thus avoided during the formulation preparation. Such method, and especially the controlled alkaline conditions, also avoids the copper oxidation during use, for example during the textile washing, thanks to the formation of a dense and nanometer silica layer covering the copper particles.

In this method, 3-glycidoxypropyltrimethoxysilane (GPTMS) is used, but all epoxy silanes as listed above comprising both epoxy and alkoxy groups may be alternatively used.

The method of preparation of the formulation according to this embodiment first comprises a step of encapsulating the metallic copper particles. This encapsulation is advantageously operated with glycerin. For this purpose, glycerin is added to a mixture of copper and ethanol.

GPTMS is added to the previously encapsulated copper solution and hydrolyzed with water under alkaline conditions. During this stage, the reaction proceeds as a nucleophilic attack of hydroxide on the silicon atom of the 3-glycidoxypropyltrimethoxysilane while the alkoxy groups are released, and the copper is bonded with the hydroxyl groups of the hydrolyzed epoxy silane. The epoxy group remains unchanged.

In parallel, graphene oxide or reduced graphene oxide is subjected to a high shear mixing operation performed for example with a Silverson mixer at about 8000 rpm for the reasons previously explained. The stabilized graphene oxide or reduced graphene oxide is then added to the hydrolyzed GPTMS and encapsulated copper solution.

In all these steps, the pH is controlled and/or adjusted for example with sodium hydroxide or ammonia to be greater or equal to 8.

Advantageously and for increasing the bonding of the active particles with the textiles, a water-based resin is added after the addition of graphene oxide or reduced graphene oxide. The water-based resin may be a polyurethane resin, an acrylic water-based resin, a polyester-resin or a mixture thereof.

Advantageously and for increasing the filtration efficacy of the antiviral filtering material, a functionalized nanosilica suspension is added to the formulation after the addition of graphene oxide and of the water-based resin if any. The quantity of the nanosilica component depends on the textile porosity and nature of the textile.

Method of Preparation of an Antiviral Filtering Material from the Antiviral Formulation

Both antiviral formulations (water-based resin and epoxy silane) are stable and can be stored before the coating operation.

The textile is impregnated with the formulation by dip coating, screen printing, spray coating or roller coating. One or more impregnations may be done depending on the capacity of the formulation to form thick layers and depending on the filtering efficacy sought.

A thermal curing operation is applied for each impregnation. Typically, the curing of the coated textile is operated at a temperature comprised between 70 and 230° C. during 1 to 13 minutes.

Alternative curing technologies like infrared curing, UV curing may also be used, possibly in combination with thermal curing.

During the curing and for both formulations (water-based resin and epoxy silane as bonding matrix material), a network anchoring graphene oxide or reduced graphene oxide, the copper particles and the optional functionalized nanosilica is formed. In both cases, the so formed bonding matrix attaches to the textile. In the case of using 3-glycidoxypropyltrimethoxysilane, the 3D silica network bounds to the textile via the epoxy groups.

### EXAMPLES

### Example 1: Preparation of an Aqueous Dispersion of Low Content Metallic Copper Nanoparticles and Reduced Graphene Oxide in the Method of Preparation of an Antiviral Formulation Using a Water-Based Resin as Bonding Matrix Material

During this preparation, the pH is adjusted at every step to keep it between 7 and 8.

0.6 grams of a solvent-free wetting and dispersing additive (DISPERBYK-2010 commercialized by BYK) are added to 1 liter of demineralized H₂O whose pH has been previously adjusted between 7 and 8. 10 grams of powder of reduced graphene oxide are added the solution. The mixture is submitted to a high-speed high shear mixer (Silverson®) at 8000 rpm during 80 minutes and then putted in an ice bath.

In parallel 0.1 gram of copper nanoparticles, having a particle size distribution between 40 nm and 60 nm, with a median particle diameter D50 between 40 nm and 60 nm and a particle diameter D90 below 60 nm, are added to a mixture of 10 ml of ethanol and 3 drops of solvent-free wetting and dispersing additive (DISPERBYK-2010 commercialized by BYK). This solution is processed by ultrasounds for 10 minutes and added dropwise to the previously prepared solution of reduced graphene oxide and submitted to the high-speed high shear mixer (Silverson®) at 8000 rpm during 15 minutes. Finally, a centrifugation at 2000 rpm during 15 minutes is operated. The resulting supernatant is separated then forming the aqueous dispersion of low content metallic copper nanoparticles and reduced graphene oxide.

### Example 2: Preparation of an Aqueous Dispersion of High Content Metallic Copper Nanoparticles and Reduced Graphene Oxide in the Method of Preparation of an Antiviral Formulation Using a Water-Based Resin as Bonding Matrix Material

This preparation is the same as for example 1 except that the final centrifugation is operated at 1000 rpm during 10 minutes.

### Example 3: Preparation of an Aqueous Dispersion of Metallic Copper Nanoparticles and Graphene Oxide in the Method of Preparation of an Antiviral Formulation Using a Water-Based Resin as Bonding Matrix Material

As for Examples 1 and 2, the pH is adjusted at every step to keep it between 7 and 8.

0.6 grams of a solvent-free wetting and dispersing additive (DISPERBYK-2010 commercialized by BYK) are added to 1 liter of demineralized H₂O whose pH has been previously adjusted between 7 and 8. 10 grams of powder of graphene oxide are added the solution. The mixture is submitted to a high-speed high shear mixer (Silverson®) at 8000 rpm during 60 minutes and then put in an ice bath.

In parallel, 0.1 gram of copper nanoparticles, having a particle size distribution between 40 nm and 60 nm, with a median particle diameter D50 between 40 nm and 60 nm and a particle diameter D90 below 60 nm, are added to a mixture of 10 ml of ethanol and 3 drops of solvent-free wetting and dispersing additive (DISPERBYK-2010 commercialized by BYK). This solution is processed by ultrasounds for 10 minutes and added dropwise to the previously prepared solution of graphene oxide and submitted to the high-speed high shear mixer (Silverson®) at 5000 rpm during 20 minutes. No further centrifugation is needed due to the stability of graphene oxide. The supernatant is separated then forming the aqueous dispersion of metallic copper nanoparticles and graphene oxide.

### Example 4: Preparation of an Antiviral Formulation Using a Water-Based Polyurethane Resin as Bonding Matrix Material

The aqueous dispersion of Example 1, Example 2 or Example 3 is added to a polyurethane dispersion (Alberdingk® U9000) while stirring at 250 rpm in a magnetic stirrer in a ratio of 1:1. The pH of both dispersions is previously controlled or adjusted with acetic acid or potassium hydroxide to be between 7 and 8. Optionally, an aqueous dispersion of colloidal nanosilica (Levasil® CC301) is also added.

### Example 5: Preparation of an Antiviral Formulation Using a Water-Based Acrylic Resin as Bonding Matrix Material

This preparation is the same as for example 4 except that the resin used is an acrylic dispersion comprising Alberdingk® AC2410 and Alberdingk® AS2685. The ratio between Alberdingk® AC2410 and Alberdingk® AS2685 is between 20:1 and 1:20.

### Example 6: Preparation of an Antiviral Formulation Using an Epoxy Silane as Bonding Matrix Material According to a First Embodiment

The pH of a solution of 9 ml of H₂O and 72 ml of ethanol is adjusted to 8-9 with 1M sodium hydroxide. In parallel, 10 ml of glycerin is adjusted to pH 8-9 with 1M sodium hydroxide. 0.5 grams of copper nanoparticles, having a particle size distribution between 40 nm and 60 nm, with a median particle diameter D50 between 40 nm and 60 nm and a particle diameter D90 below 60 nm, in 10 ml of ethanol is submitted to ultrasound sonication and added to the glycerin. The pH is adjusted to 8-9. The ethanol solution and the glycerin and copper nanoparticles mixture are mixed together.

9 ml of a GPTMS solution is added to the previous mixture of ethanol and glycerin and copper nanoparticles under magnetic stirring, the pH is adjusted to 8-9 with 1 M sodium hydroxide and such solution is added to the previous prepared solution of encapsulated nanoparticles. The mixture is operated during 6 to 8 hours for hydrolyzation of the GPTMS to happen. Under alkaline hydrolyzation a small and dense silica network is obtained.

In parallel, 0.6 grams of a solvent-free wetting and dispersing additive (DISPERBYK-2010 commercialized by BYK) are added to 1 liter of demineralized H₂O whose pH has been adjusted between 7 and 8. 1.64 grams of powder of graphene oxide are added the solution. The mixture is submitted to a high-speed high shear mixer (Silverson®) at 8000 rpm during 60 minutes and then put in an ice bath.

The pH of the solution of graphene oxide is adjusted to 8-9 and such adjusted solution is added to the previous prepared mixture of hydrolyzed GPTMS and encapsulated nanoparticles. The pH is further adjusted between 8 to 9.

Finally, such solution is added drop by drop to an acrylic water-based resin (Alberdingk® AC2410) then obtaining the antiviral formulation with a ratio GPTMS:graphene oxide:resin of 11:48:32.

When using reduced graphene oxide instead of graphene oxide, the same method of preparation is applied except for the preparation of the solution of reduced graphene oxide for which the high shear mixing operation is conducted at 8000 rpm during 80 minutes.

### Example 7: Preparation of an Antiviral Formulation Using an Epoxy Silane as Bonding Matrix Material According to a Second Embodiment

This preparation is the same as for example 6, except for the final step for which the solution is added drop by drop to a siloxane oligomer (Dynasylan® Hydroxyl 2627).

### Example 8: Antiviral Activity of the Antiviral Filtering Material Comprising an Antiviral Formulation Prepared from Graphene Oxide and Polyurethane Resin

An antiviral formulation is prepared as follows. The aqueous dispersion of Example 3 using graphene oxide at 2.5 g/L and a concentration of copper nanoparticles of 0.2 g/L is added to a polyurethane dispersion (Alberdingk® U9000) while stirring at 250 rpm in a magnetic stirrer. The pH of both dispersions is previously controlled or adjusted between 7 and 8. An aqueous dispersion of colloidal nanosilica (Levasil® CC301) is also added.

The ratio of graphene oxide: copper is 12.5:1 and the ratio of graphene oxide+copper suspension:polyurethane is 3:2.

The following textiles are tested:
Sontara® has a mean density of 55 g/m² and comprises 50.4% of cellulose and 49.6% of polyethylene.
Geopunch® 100 (Geopannel) has a density of 100 g/m² and comprises 80% of polypropylene and 20% of polyethylene.

The coating and curing steps are operated as follows:
coating: 2 steps of dip coating process at 200 mm/min and a holding time of 10 s
curing: 2 curing steps of 13 minutes at 90° C.

The TCID50 titration method is used for determining the antiviral activity according to ISO 18184-2019 standard. The TCID50 (Median Tissue Culture Infectious Dose) is one of the methods used when verifying viral titer. It means the concentration at which 50% of the cells are infected when a test tube or well plate upon which cells have been cultured is inoculated with a diluted solution of viral fluid. This is the preferred method in ISO 18184 standard for determination of antiviral activity in textiles.

Measurements of the antiviral activity against a murine norovirus are conducted just after the coating and curing steps (t=0), and 24 h later (t=24 h). The antiviral measurements are also both made on each tested textile with and without any coating.

The results in terms of logarithmic reductions are given in Table 1.

TABLE 1

| Time after coating | | Logarithmic |
|---|---|---|
| (hours) | Material | reduction |
| t = 0 | Sontara ® without coating | 0.25 |
| | Sontara ® with coating | >5.17 |
| t = 24 | Sontara ® without coating | 3.71 |
| | Sontara ® with coating | >5.17 |
| t = 0 | Geopunch ® 100 without coating | 0.12 |
| | Geopunch ® 100 with coating | 3.42 |
| t = 24 | Geopunch ® 100 without coating | 2.75 |
| | Geopunch ® 100 with coating | >5.17 |

A logarithmic reduction >5.17 means that the reduction is higher than the limits of detection. Knowing that a logarithmic reduction of 3.71 corresponds to an antiviral efficiency of 99, 9804%, the antiviral efficiency of the antiviral filtering material of the invention is conclusive.

At t=0, the Sontara® textile shows a remarkable logarithmic reduction >5.17. The logarithmic reduction of the Geopunch® 100 textile at t=0 is also very conclusive.

At t=24, both coated textiles show a logarithmic reduction >5.17.

Although reductions are obtained on textiles without coating after 24 h, the time needed to reach these reductions is way too long. A significant reduction has to be reached rapidly for satisfactory results.

### Example 9—Filtration Efficiency and Respirability of the Antiviral Filtering Material

The filtration efficiency and the respirability of three antiviral filtering materials of the invention are evaluated.

Referring to Table 2, the tested formulations are as follows:
antiviral formulation 1: the antiviral formulation is according to Example 4 except that the aqueous dispersion of Example 2 is used and that no dispersion of colloidal nanosilica is added in the formulation. The ratio of the polyurethane dispersion and the aqueous dispersion of copper nanoparticles and reduced graphene oxide is 1:1.
antiviral formulation 2: the antiviral formulation is according to Example 4 except that the aqueous dispersion of Example 2 is used. The dispersion of colloidal nanosilica (Levasil® CC301) is added in the formulation. The ratio of the polyurethane dispersion and the aqueous dispersion of copper nanoparticles and reduced graphene oxide is 1:1.
formulation 3 is a pure polyurethane resin (Alberdingk®9000) and therefore outside the scope of the invention.

The textile used for each sample is Sontara® which has a mean density of 55 g/m² and which comprises 50.4% of cellulose and 49.6% of polyethylene.

The coating of each sample is operated with two dip coatings, each of them at a speed of 200 mm/min with a holding time of 10 seconds. The curing operation is conducted at 90° C. during 5 minutes after the first dip coating and at 90° C. during 10 minutes after the second dip coating.

The results in terms of visual aspect, adhesion, filtration efficiency and respirability are given in Table 2.

TABLE 2

| | | | Filtration | |
|---|---|---|---|---|
| Formulation | Visual aspect | Adhesion | efficiency (%) | Respirability |
| 1 | Good | Good | 80 | Good |
| 2 | Good | Good | 90 | Good |
| 3 | Good | Good | 60-70 | Good |

Filtration efficiency of the antiviral filtering material of the invention is improved compared to a polyurethane coating. The respirability, the visual aspect and the adhesion properties are also validated for each sample.

### Example 10: Filtration Efficiency and Pressure Drop of the Antiviral Filtering Material

Filtration efficiency of filtering materials is evaluated in view of the pressure drop.

For each sample, the textile is Sontara® which has a mean density of 55 g/m² and which comprises 50.4% of cellulose and 49.6% of polyethylene.

Referring to Table 3 the tested filtering materials are as follows:
material 1: Sontara® textile without any coating
material 2: the Sontara® textile is coated with the formulation according to Example 4 except that the aqueous dispersion of Example 2 is used. No dispersion of colloidal nanosilica (Levasil® CC301) is added in the formulation. The ratio of the polyurethane dispersion and the aqueous dispersion of copper nanoparticles and reduced graphene oxide is 1:1.
material 3: the same as for material 2 except that the dispersion of colloidal nanosilica (Levasil® CC301) is added in the formulation according to example 4.
material 4: the Sontara® textile is coated with a polyurethane resin (Alberdingk® U9000)
material 5: the Sontara® textile is coated with the formulation according to Example 4 except that the aqueous dispersion of Example 3 with graphene oxide is used at a concentration of 5.5 g/L of graphene oxide and of 0.2 g/L of copper nanoparticles is obtained after dilution 1:1 with water starting from a concentration of graphene oxide of 11.5 g/L and from a concentration of copper nanoparticles of 0.5 g/L. No dispersion of colloidal nanosilica (Levasil® CC301) is added in the formulation.

TABLE 3

| | Dip 1 - | Dip 2 - | | | |
|---|---|---|---|---|---|
| | Curing | Curing | Curing | | |
| | time | time | time | | Filtration |
| | duration | duration | temperature | Pressure | efficiency |
| Material | (min) | (min) | (° C.) | drop (mm) | (%) |
| 1 | — | — | — | 84 | 60 |
| 2 | 5 | 10 | 90 | 110 | 93 |
| 3 | 5 | 10 | 90 | 110 | 88 |
| 4 | 10 | — | 90 | 178 | 65 |
| 5 | 7 | — | 150 | 110 | 80 |

These results show that contrary to what was expected, a higher drop pressure is not necessarily linked with greater filtration efficiency. For material 4 the pressure drop is of 178 mm for a filtration efficiency of 65% while for the preferred material 2, the pressure drop is of 110 mm for a filtration efficiency of 93%.

### Example 11: Antiviral Activity of the Antiviral Material Comprising an Antiviral Formulation Prepared from Graphene Oxide and Polyurethane Resin

Referring to Table 4, the antiviral formulations are prepared as follows. The aqueous dispersion of Example 3 using graphene oxide at 2.5 g/L and a concentration of copper nanoparticles of 0.5 g/L is added to a polyurethane dispersion (Alberdingk® U9000) while stirring at 250 rpm in a magnetic stirrer. The pH of both dispersions is previously controlled or adjusted between 7 and 8.

The ratio of graphene oxide: copper is 5:1 and the ratio of graphene oxide+copper suspension:polyurethane is 1.5:1 or 150:1 depending on the case.

The Sontara® textile previously described is used.

The coating and curing steps are operated as follows:
coating: 1 step of dip coating process at 200 mm/min and a holding time of 10 s
curing: 1 curing step of 13 minutes at 90° C.

The TCID50 titration method as described above is used for determining the antiviral activity according to ISO 18184-2019 standard.

TABLE 4

| | Ratio GO- | Type of | Logarithmic | |
|---|---|---|---|---|
| Textile | Cu:resin | virus | reduction | Deactivation, % |
| Sontara ® | 150:1 | Murine | 2.55 | 99.718 (t = 2 h) |
| | | norovirus | | |
| Sontara ® | 1.5:1 | Murine | 4.88 | 99.998 (t = 0 h) |
| | | norovirus | | |

At t=0 h, the coated Sontara® textile shows a remarkable antiviral efficacy of 99.998% against murine norovirus when using a 1.5:1 ratio. When increasing the ratio up to 150:1, the antiviral efficacy is 99.718% after 2 h against the same type of virus.

### Example 12: Antiviral Activity of the Antiviral Material Comprising an Antiviral Formulation Prepared from Graphene Oxide and Polyurethane Resin

The antiviral formulations are prepared as follows. The aqueous dispersion of Example 3 using graphene oxide at 1 g/L and a concentration of copper nanoparticles of 0.5 g/L is added to a polyurethane dispersion (Alberdingk® U9000) while stirring at 250 rpm in a magnetic stirrer. The pH of both dispersions is previously controlled or adjusted between 7 and 8.

The ratio of graphene oxide: copper is 2:1 and the ratio of graphene oxide+copper suspension:polyurethane is 150:1.

The Sontara® textile previously described is used.

The coating and curing steps are operated as follows:
coating: 1 step of dip coating process at 200 mm/min and a holding time of 10 s
curing: 1 curing step of 13 minutes at 90° C.

The TCID50 titration method as described above is used for determining the antiviral activity according to ISO 18184-2019 standard.

TABLE 5

| | Ratio GO- | Type of | Logarithmic | |
|---|---|---|---|---|
| Textile | Cu:resin | virus | reduction | Deactivation, % |
| Sontara ® | 150:1 | 229E | 4.08 | 99.992 (t = 3 h) |
| | | coronavirus | | |

At t=3 h, the Sontara® textile shows a remarkable antiviral efficacy of 99.992% against 229E coronavirus when using a 150:1 ratio.

### Example 13: Antiviral Activity of the Antiviral Material Comprising an Antiviral Formulation Prepared from Graphene Oxide and Acrylic Resin

The antiviral formulations are prepared as follows. The aqueous dispersion of Example 3 using graphene oxide at 1 g/L and a concentration of copper nanoparticles of 0.5 g/L is added to an acrylic dispersion comprising Alberdingk® AC2410 and Alberdingk® AS2685 while stirring at 250 rpm in a magnetic stirrer. The ratio between Alberdingk® AC2410 and Alberdingk® AS2685 is 3:1. The pH of both dispersions is previously controlled or adjusted between 7 and 8.

The ratio of graphene oxide: copper is 2:1 and the ratio of graphene oxide+copper suspension:acrylic is 15:1.

The Sontara® textile previously described is used.

The coating and curing steps are operated as follows:
coating: 1 steps of dip coating process at 200 mm/min and a holding time of 10 s
curing: 1 curing steps of 13 minutes at 90° C.

The TCID50 titration method as described above is used for determining the antiviral activity according to ISO 18184-2019 standard.

TABLE 6

| | Ratio GO- | Type of | Logarithmic | |
|---|---|---|---|---|
| Textile | Cu:resin | virus | reduction | Deactivation, % |
| Sontara ® | 15:1 | 229E | 2.63 | 99.766 (t = 3 h) |
| | | coronavirus | | |

At t=3 h, the Sontara® textile shows a remarkable antiviral efficacy of 99.766% against 229E coronavirus when using a 15:1 ratio.

### Example 14: Preparation of an Aqueous Dispersion of Metallic Copper Particles and Graphene Oxide in the Method of Preparation of an Antiviral Formulation Using a Water-Based Resin as Bonding Matrix Material

During this preparation, the pH is adjusted at every step to keep it between 7 and 8. 0.6 grams of a solvent-free wetting and dispersing additive (DISPERBYK-2010 commercialized by BYK) are added to 1 liter of demineralized H₂O whose pH has been previously adjusted between 7 and 8. 10 grams of powder of graphene oxide are added the solution. The mixture is submitted to a high-speed high shear mixer (Silverson®) at 8000 rpm during 60 minutes and then putted in an ice bath.

In parallel, 0.1 gram of copper particles, having a particle size distribution between 100 nm and 200 nm, with a median particle diameter D50 between 100 nm and 200 nm and a particle diameter D90 below 200 nm, are added to a mixture of 10 ml of ethanol and 3 drops of solvent-free wetting and dispersing additive (DISPERBYK-2010 commercialized by BYK). This solution is processed by ultrasounds for 10 minutes and added dropwise to the previously prepared solution of graphene oxide and submitted to the high-speed high shear mixer (Silverson®) at 5000 rpm during 20 minutes. No further centrifugation is needed due to the stability of graphene oxide. The supernatant is separated then forming the aqueous dispersion of metallic copper nanoparticles and graphene oxide.

### Example 15: Antiviral Activity of the Antiviral Material Comprising an Antiviral Formulation Prepared from Graphene Oxide and Polyurethane Resin

The antiviral formulation is prepared as follows. The aqueous dispersion of Example 14 using graphene oxide at 2.5 g/L and a concentration of copper particles of 0.5 g/L is added to a polyurethane dispersion (Alberdingk® U9000) while stirring at 250 rpm in a magnetic stirrer. The pH of both dispersions is previously controlled or adjusted between 7 and 8.

The ratio of graphene oxide: copper is 5:1 and the ratio of graphene oxide+copper suspension:polyurethane is 50:1.

The Sontara® textile previously described is used.

The coating and curing steps are operated as follows:
coating: 1 step of padding process at a roller pressure of 4 kg/cm² and a line speed of 15 m/min.
curing: 1 curing step of 1 min at 110° C.

The TCID50 titration method as described above is used for determining the antiviral activity according to ISO 18184-2019 standard.

TABLE 7

| | Ratio GO- | Type of | Logarithmic | |
|---|---|---|---|---|
| Textile | Cu:resin | virus | reduction | Deactivation, % |
| Sontara ® | 50:1 | Murine | 1.88 | 98.68 (t = 2 h) |
| | | norovirus | | |
| Sontara ® | 50:1 | 229E | 2.00 | 99.00 (t = 3 h) |
| | | coronavirus | | |

Under industrial-representative coating conditions, the Sontara® textile shows an antiviral efficacy of 98.68% at 2 h against murine norovirus and 99.00% at 3 h against 229E coronavirus when using a 50:1 ratio.

### Example 16: Antiviral Activity of the Antiviral Material Comprising an Antiviral Formulation Prepared from Graphene Oxide and Acrylic Resin

The antiviral formulation is prepared as follows. The aqueous dispersion of Example 14 using graphene oxide at 2.5 g/L and a concentration of copper particles of 0.5 g/L is added to an acrylic dispersion comprising Alberdingk® AC2410 and Alberdingk® AS2685 while stirring at 250 rpm in a magnetic stirrer. The ratio between Alberdingk® AC2410 and Alberdingk® AS2685 is 3:1. The pH of both dispersions is previously controlled or adjusted between 7 and 8.

The ratio of graphene oxide: copper is 5:1 and the ratio of graphene oxide+copper suspension:acrylic is 18.75:1.

The following textile is tested:
Polypropylene with a density of 30 g/m²

The coating and curing steps are operated as follows:
coating: 1 step of padding process at 1 kg/cm² and rolling speed of 2 rpm
curing: 1 curing step of 5 minutes at 130° C.

The TCID50 titration method as described above is used for determining the antiviral activity according to ISO 18184-2019 standard.

TABLE 8

| | Ratio GO- | Type of | Logarithmic | |
|---|---|---|---|---|
| Textile | Cu:resin | virus | reduction | Deactivation, % |
| Polypropylene | 18.75:1 | Murine | 1.37 | 95.7 (t = 0 h) |
| | | norovirus | | |

At t=0 h, the polypropylene textile shows an antiviral efficacy of 95.7% against murine norovirus when using a 18.75:1 ratio.

What is claimed is:

1-28. (canceled)

29: Antiviral formulation comprising:
metallic copper particles in an unoxidized form and having a median particle diameter inferior or equal to 200 nm;
graphene oxide or reduced graphene oxide; and
a bonding matrix material.

30: The antiviral formulation as recited in claim 29 wherein the metallic copper particles and the graphene oxide or the reduced graphene oxide are chemically bonded.

31: The antiviral formulation as recited in claim 29 wherein the bonding matrix material includes a water-based resin.

32: The antiviral formulation as recited in claim 31 wherein the water-based resin is a polyurethane resin, an acrylic resin, a polyester resin, oligomers or mixtures thereof.

33: The antiviral formulation as recited in claim 32 wherein the water-based resin is polyurethane resin or acrylic resin, wherein the ratio between graphene oxide or reduced graphene oxide, and metallic copper particles is between 62:1 to 1:1, and wherein the ratio between graphene oxide or reduced graphene oxide and copper suspension, and the resin is between 1:1 and 600:1.

34: The antiviral formulation as recited in claim 32 wherein further comprising a functionalized nanosilica component.

35: The antiviral formulation as recited in claim 29 wherein the bonding matrix material includes an alkaline hydrolyzed epoxy silane.

36: The antiviral formulation as recited in claim 35 wherein the copper particles are encapsulated.

37: Antiviral filtering material comprising:
a layer of textile; and
at least one layer of an antiviral coating including: metallic copper particles in an unoxidized form and having a median particle diameter inferior or equal to 200 nm; graphene oxide or reduced graphene oxide; and a bonding matrix, both the metallic copper particles and the graphene oxide or reduced graphene oxide being anchored in the boding matrix.

38: The antiviral filtering material as recited in claim 37 wherein the bonding matrix further includes a functionalized nanosilica component.

39: The antiviral filtering material as recited in claim 37 wherein the bonding matrix includes a water-based resin.

40: The antiviral filtering material as recited in claim 39 wherein the water-based resin is a polyurethane resin, an acrylic resin, a polyester resin, oligomers or mixtures thereof.

41: The antiviral filtering material as recited in claim 40 wherein the water-based resin is polyurethane resin or acrylic resin, wherein the ratio between graphene oxide or reduced graphene oxide, and metallic copper particles is between 62:1 to 1:1, and wherein the ratio between graphene oxide or reduced graphene oxide and copper suspension and the resin is between 1:1 and 1500:1.

42: The antiviral filtering material as recited in claim 40 wherein the bonding matrix includes a functionalized nanosilica network into which both graphene oxide and metallic copper particles are chemically bonded.

43: The antiviral filtering material as recited in claim 37 wherein the textile includes natural fibers, synthetic fibers or a mixture thereof.

44: A method of preparation of an antiviral formulation, the method comprising at least the following steps:
preparing in alkaline conditions an aqueous dispersion of metallic copper particles having a median particle diameter inferior or equal to 200 nm and stabilized graphene oxide or stabilized reduced graphene oxide; and
mixing said aqueous dispersion with a bonding matrix material under alkaline conditions so as to obtain an antiviral formulation comprising metallic copper particles in an unoxidized form, graphene oxide or reduced graphene oxide and a bonding matrix material.

45: The method as recited in claim 44 wherein the preparation of the aqueous dispersion of metallic copper particles and graphene oxide or reduced graphene oxide includes the following steps:
stabilizing graphene oxide or reduced graphene oxide by mixing with a solvent, for example water, and a dispersing additive
adding metallic copper particles in the solution and high shear mixing the resulting preparation,
centrifugating the resulting preparation, and
collecting the supernatant so as to obtain the aqueous dispersion of metallic copper particles and stabilized graphene oxide or stabilized reduced graphene oxide,
wherein all these operations are conducted under alkaline conditions.

46: The method as recited in claim 44 wherein the bonding matrix material includes polyurethane resin, acrylic resin, polyester resin, oligomers or a mixture thereof.

47: The method as recited in claim 44 further comprising adding an aqueous dispersion of functionalized nanosilica after mixing the aqueous dispersion with the bonding matrix material.

48: A method of preparation of an antiviral formulation, the method comprising at least the following steps:
encapsulating metallic copper particles having a median particle diameter inferior or equal to 200 nm,
adding the epoxy silane to the encapsulated metallic copper particles,
hydrolyzing the epoxy silane under sol-gel process conditions,
adding graphene oxide or reduced graphene oxide under sol-gel process conditions,
wherein all the steps are operated under alkaline conditions,
so as to obtain an antiviral formulation including metallic copper particles in an unoxidized form, graphene oxide or reduced graphene oxide, and a bonding matrix material.

49: The method as recited in claim 48 wherein the epoxy silane is 3-glycidoxypropyltrimethoxysilane.

50: The method as recited in claim 48 wherein the encapsulation of the copper particles is operated with glycerin, polyvinyl acetate, or lignin.

51: The method as recited in claim 48 further comprising adding a water-based resin after adding graphene oxide or reduced graphene oxide.

52: A method of preparation of an antiviral filtering material, the method comprising at least the following steps:
preparing an antiviral formulation according to the method as recited in claim 44;
supplying a textile and coating said textile with said antiviral formulation, and
curing the coated textile so as to obtain an antiviral filtering material.

53: The method as recited in claim 52 wherein the step of coating the textile with the antiviral formulation is a dip coating, screen printing, spray coating or roller coating.

54: The method as recited in claim 52 wherein the curing of the coated textile is operated at a temperature comprised between 70 and 230° C. during 1 to 13 minutes.

55: An antiviral face mask made from an antiviral filtering material comprising a layer of textile coated with an antiviral formulation comprising metallic copper particles in an unoxidized form and having a median particle diameter inferior or equal to 200 nm, and graphene oxide or reduced graphene oxide, and a bonding matrix into which both metallic copper particles and graphene oxide or reduced graphene oxide are anchored.

56: The antiviral face mask as recited in claim 55 wherein the antiviral formulation further comprises a functionalized nanosilica component.
